(19) United States
(12) Patent Application Publication
(10) Pub. No.: US 2011/0149294 A1
(43) Pub. Date: Jun. 23, 2011

(54) INTEGRATED INTERFEROMETRIC APPARATUS AND BIO DETECTION SENSOR SYSTEM USING IT

(75) Inventor: Hyun Woo Song, Daejeon (KR)

(73) Assignee: Electronics and Telecommunications Research Institute, Daejeon (KR)

(21) Appl. No.: 12/961,765

(22) Filed: Dec. 7, 2010

(30) Foreign Application Priority Data
Dec. 18, 2009 (KR) 10-2009-0127512
Apr. 12, 2010 (KR) 10-2010-0033519

(51) Int. Cl. G01B 9/02; G01N 21/00

(52) U.S. Cl. 356/477

(57) ABSTRACT

There are provided an integrated interferometric apparatus and a bio sensor system using the same. In more detail, an integrated interferometric apparatus, comprising: first to fourth ports through which optical signals are input and output, a coupler branching and coupling the optical signals and first to fourth optical waveguides connecting the first to fourth ports to the coupler and transmitting optical signals, wherein the coupler branches the optical signals input from the first port and transmits them to the second port and the third port and couples the optical signals transmitted from the second port and the third port and transmits them to the fourth port, and the first port and the fourth port are disposed so that the first optical waveguide connected to the first port is orthogonal to the fourth optical waveguide connected to the fourth port.

### CROSS-REFERENCE TO RELATED APPLICATIONS

This application claims the priorities of Korean Patent Application Nos. 10-2009-0127512 filed on Dec. 18, 2009 and 10-2010-0033519 filed on Apr. 12, 2010, in the Korean Intellectual Property Office, the disclosures of which are incorporated herein by reference.

### BACKGROUND OF THE INVENTION

1. Field of the Invention

The present invention relates to an apparatus for optically sensing bio materials using an interferometer and a sensor system using the same. More specifically, the present invention relates to an apparatus for sensing changes in the refractive indexes of bio materials by specific reactions using a mechanism of antigen-antibody reaction by using several interferometers and a sensor system using the same.

2. Description of the Related Art

Areas within the field of medicine, such as disease diagnosis, the preparation of new medicines or toxicity tests, or the like; applications within the field of bio chips, such as environmental pollution material research, virus detection within the environment or for determining the presence of contaminants in foods, or the like, and industries related thereto have become greatly diversified.

A bio chip is a hybrid device having existing semiconductor chip form by combining bio organic materials such as an enzyme, a protein, an antibody, deoxyribonucleic acid (DNA), a microorganism, a plant or animal cell or organ, a nervous system cell or organ, a nervous system cell, or the like with inorganic materials such as glass, or the like. The bio chip serves as a functional new device for diagnosing an infectious disease, analyzing a gene, and processing new information by using a unique function of biomolecule and imitating the bio function.

As a method of detecting bio signals from the bio chip, there is a method for tagging fluorescent materials with a material such as an enzyme, or the like, on bio samples or a method for detecting bio signals in a non-tagging form such as an electrochemical reaction or surface plasmon resonance (SPR), or the like, for the bio samples. The tagging method senses that the optical signals and the tagging method using materials such as fluorescent materials and enzymes, or the like, is advantageous in low-concentration sensing. Generally, since the bio signals frequently exist at a low concentration, the tagging method using a fluorescent material and a material such as an enzyme or the like, has mainly been used to this point.

The bio detection sensor optically sensing the bio signals may have various methods and structures. The bio detection sensor may use a method of directly measuring the intensity of optical signals generated from the tagging materials and a method of measuring optical interference signals using the interferometer. In particular, as the interferometer used for the method of measuring optical interference signals, there are provided a zero interferometer, a Mach-Zender interferometer, and a Michelson interferometer.

The bio detection sensor measuring the presence of a virus by using the zero interferometer shows very high sensitivity and can directly measure the presence of a virus in real time. Even in the case that the bio detection sensor is applied to sense the presence of the herpes simplex virus, it can be applied to a general application. Virus particles are measured by fixing viruses to a surface of a measuring arm with respect to a reference arm of the interferometer and measuring the movement of interference fringe thereof due to light interference emitted from the reference arm and the measuring arm. It is shown that viruses, even having a very low concentration of 850 particles/ml, can be measured using the bio detection sensor. Further, it was shown from extrapolation results that even a single virus can be sensed.

In the bio detection sensor measuring the combination of chemical or biological species, in interferometer using the Mach-Zender interferometer, the Mach-Zender interferometer is configured to use a polymer optical waveguide. The combination of chemical or biological species is measured by measuring the change in interference signals due to the interference of light emitted from the reference arm and the measuring arm by combining the chemical or biological species on the surface of the measuring arm with respect to the reference arm of the interferometer. The bio detection sensor measures the change in refractive indexes of the chemical or biological species on the polymer substrate.

However, when the interferometer is used, there is a problem in that the bio detection sensor should be designed and manufactured by integrating the bio chip with the interferometric system.

Further, the Michelson interferometer is designed to have a structure in which the bio chip serving as a reacting unit and an interferometric sensor serving as a sensing unit can be separated from each other. Since the bio chip can be separated from the interferometric sensor, the bio chip can be used as a disposable reaction chip.

However, when the above-mentioned interferometers are used, as the path through which optical signals are wave-guided becomes longer, noise due to outside environmental effects such as temperature, magnetic field, deformation (torsion, tension, pressure, and the like), and vibration is increased, such that the limit of detection of signals to be measured is increased and the signal to noise ratio is deteriorated.

For example, in the case of the optical waveguide using silica, since the change in optical path due to temperature is a value obtained by multiplying the length of the interference arm by the temperature dependency coefficient (dn/dT=1×10−5 1/° C.) of the refractive index, the effect of the change in external temperature on the optical path is increased as the length of the reference arm and the sensing arm become longer. Further, deformation due to magnetic field or vibration or the like, in the optical path direction, is a factor in causing the birefringence of the optical waveguide, which causes the difference in polarization of light progressing along the waveguide.

FIG. 1 is a graph showing the change in refractive index over time measured as the change in intensity of interfered light while a TMB substrate of a bio chip is color-developed in a bio signal detection system using a Michelson interferometer of the related art.

The bio chip puts a TMB, an enzyme-based color developing substrate into a fluid chip channel made of a plastic material and so as to allow the for a reaction therein, the depth thereof is 0.3 mm. In addition, a metal reflector is disposed at the bottom of the fluid chip channel to increase the reflection signal. Since many enzymes exist on the surface as the concentration of protein is increased, it can be appreciated that the reaction speed of the substrate is rapid and thus, the change speed of the refractive index is very rapid. The change in interference light intensity according to the change in refractive index after and before the color development of the TMB substrate may be measured by the number of vibration periods of the interference signals for a predetermined time and the time corresponding to the change in interference signals of one period may be measured.

It can be appreciated from FIG. 1 that considerable fluctuation occurs in the square wave of the measured waveform. This phenomenon occurs due to the effect of the external environment. However, when the amount of protein of the bio chip to be measured is small, the measurement is able to be made for a long period of time. When the above-mentioned fluctuation phenomenon is large, though, it is impossible to perform the measurement.

However, when an interferometric apparatus insensitive to the external environment is used, the stability of a signal is large and thus, the very small change in refractive index may be measured. Therefore, in order to accurately detect the minute change in refractive index, the system insensitive to the external environment is prepared.

FIG. 2 is a graph showing a quantitatively calculated amount of protein of a bio chip in a bio signal detection system using a Michelson interferometer of the related art.

The graph shown in FIG. 2 shows the amount of protein by comparing the reaction speed calculated according to the amount of enzyme with the reaction speed obtained from the measuring signal, in enzyme-based substrate color developing reaction occurring in the bio chip. The quantitative value is a numerical value obtained quantification based on the measuring signal for the reaction time of 120 second.

### SUMMARY OF THE INVENTION

An aspect of the present invention provides an interferometric apparatus insensitive to environments capable of measuring bio signals in a non-contact manner and stably obtaining signals while improving measurement sensitivity of bio signals and a bio detection sensor system using the same.

According to an aspect of the present invention, there is provided an integrated interferometric apparatus, including: first to fourth ports through which optical signals are input and output; a coupler branching and coupling the optical signals; and optical waveguides connecting the first to fourth ports to the coupler and transmitting optical signals, wherein the coupler branches the optical signals input from the first port and transmits them to the second port and the third port and couples the optical signals transmitted from the second port and the third port and transmits them to the fourth port, and the first port and the fourth port are disposed so that the directions of the optical waveguide connected to the first port and the optical waveguide connected to the fourth port are orthogonal to each other.

According to another aspect of the present invention, there is provided a bio detection sensor system, including: a light generating device generating optical signals required for measurement; a reference device reflecting input optical signals; a bio chip device; a light detecting device detecting received optical signals; and an integrated interferometer apparatus that includes a first port into which optical signals of the light generating device are input, a second port transmitting and receiving the optical signals to and from the bio chip, a third port transmitting and receiving the optical signals to and from the reference device, a fourth port transmitting and receiving the optical signals to and from the light detecting device, a coupler branching the optical signals input from the first port and transmitting them to the second port and the third port and coupling the optical signals transmitted from the second port and the third port and transmitting them to the fourth port, and first to fourth optical waveguides connecting the first to fourth ports to the coupler and transmitting the optical signals, wherein the first port and the fourth port are disposed so that the direction of the first optical waveguide connected to the first port is Orthogonal to the direction of the fourth optical waveguide connected to the fourth port.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a graph showing the change in refractive index over time measured as a change in intensity of interfered light while a TMB substrate of a bio chip is color-developed in a bio signal detection system using a Michelson interferometer of the related art;

FIG. 2 is a graph showing a quantitatively calculated amount of protein of a bio chip in a bio signal detection system using a Michelson interferometer of the related art;

FIG. 3 is a plan view showing an overall structure of an integrated interferometric apparatus of the present invention;

FIGS. 4A and 4B are cross-sectional views showing a section of the integrated interferometric apparatus of the present invention;

FIG. 5 is an arrangement diagram showing a shape in which the integrated interferometric apparatus of the present invention is arranged on a wafer during a manufacturing thereof;

FIGS. 6A, 6B and 6C show configurations of each port of the integrated interferometric apparatus of the present invention; and

FIG. 7 is a diagram showing an overall configuration of a bio signal sensing system using the integrated interferometric apparatus of the present invention.

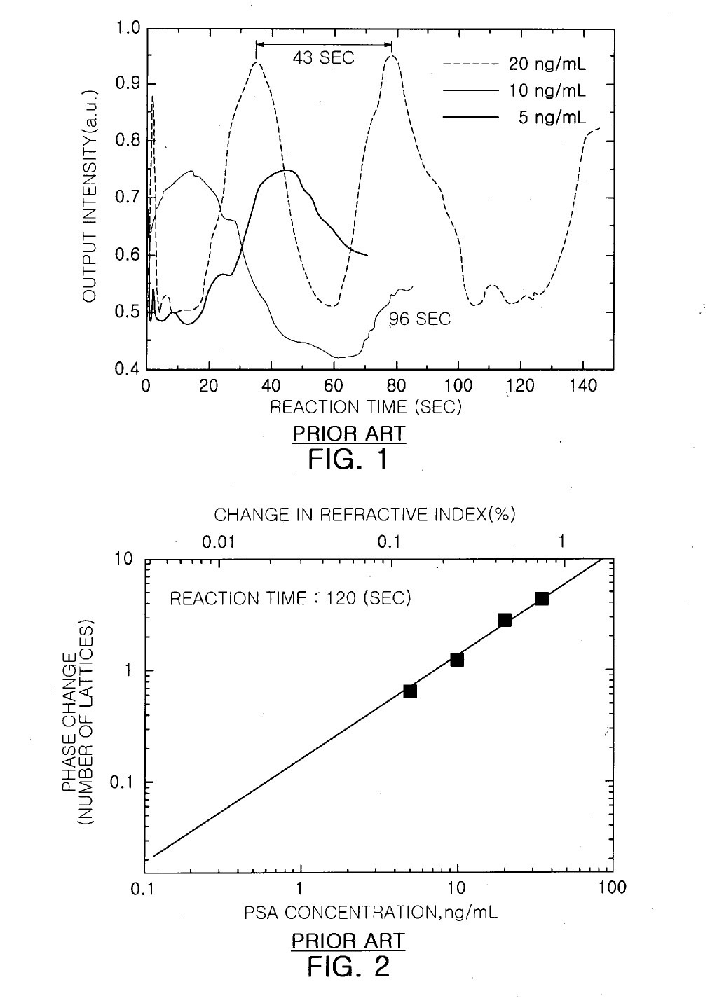

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

Unless explicitly described to the contrary, the word “comprise” and variations such as “comprises” or “comprising,” will be understood to imply the inclusion of stated elements but not the exclusion of any other elements.

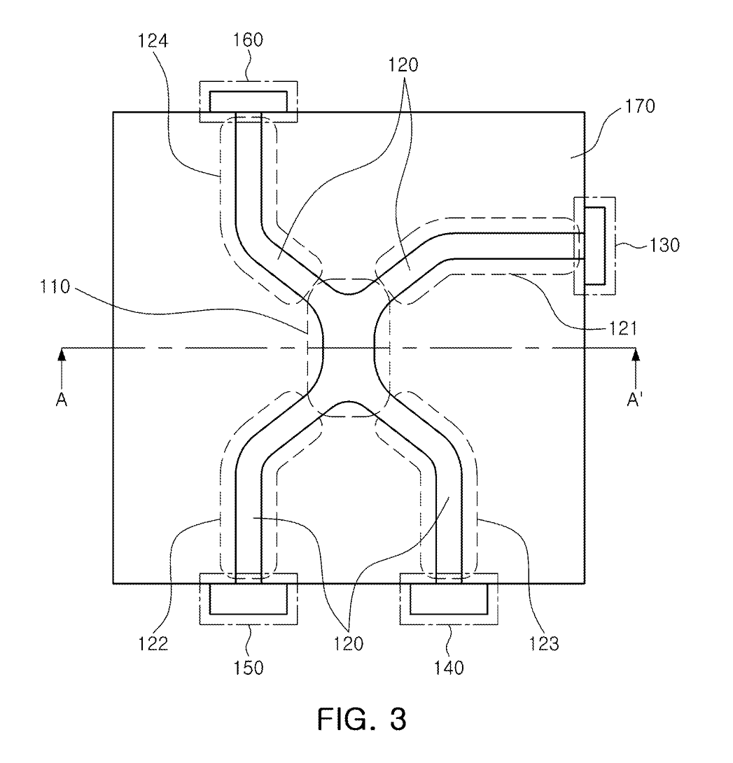

FIG. 3 is a plan view showing an overall structure of integrated interferometric apparatus of the present invention.

Referring to FIG. 3, an integrated interferometric apparatus 100 according to the present invention may be configured to include four ports 130 to 160, a coupler 110, an optical waveguide 120, and a substrate 170.

The present invention is the integrated interferometric apparatus 100, such that the ports 130 to 160, the coupler 110, and the optical waveguide 120 may be formed on the substrate 170 by etching.

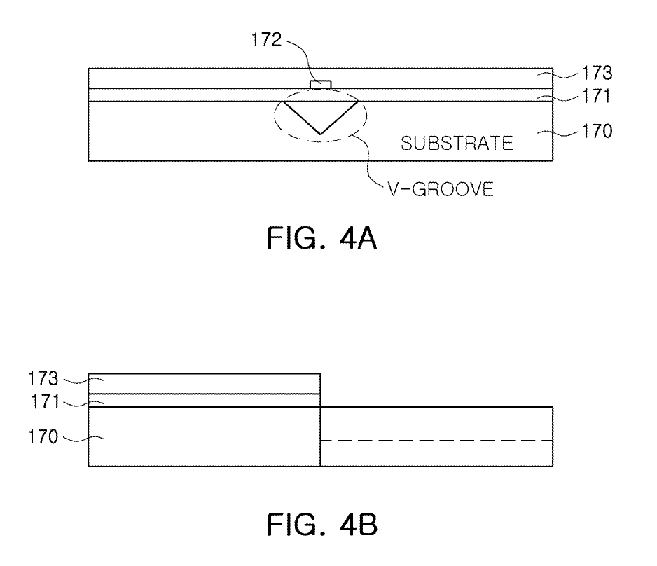

Referring to FIGS. 4A and 4B, in the integrated interferometric apparatus 100 of the present invention, a clad and a core are stacked on the silicon crystalline substrate 170 by using silicon oxide and silicon nitride, thereby forming the structure of the optical waveguide, or the like.

In order to form the ports 130 to 160, the coupler 110, and the optical waveguide 120 of the present invention, a lower clad 171, a core 172, and an upper clad 173 are sequentially stacked, thereby making it possible to manufacture the integrated interferometric apparatus 100 of the present invention.

A material having a small refractive index such as silica or polymer functioning as the lower clad 171 on the substrate 170 is applied over the substrate 170 and the silica or polymer having a relatively large refractive index is stacked, thereby forming a core 172 layer. After the core 172 layer is etched to be formed as the waveguide, materials having low refractive index such as silica material or polymer are applied over the substrate to form the upper clad 173, thereby completing the integrated interferometric apparatus 100 of the present invention.

In addition, the clad portion of the optical waveguide is configured by being filled with materials having the refractive index smaller than the core portion. The optical waveguide can be manufactured by a process of using an oxide film or a nitride film. In addition, the optical waveguide may be manufactured using the polymer material. The two methods can precisely control the refractive indexes of the core part and the clad part of the optical waveguide, such that the size of the core of the optical waveguide and the curvature of the optical waveguide can be designed in consideration of these refractive indexes. Therefore, the interval between the reference arm and the sensing arm is from 0.05 mm to several tens of mm and the curvature radius can be manufactured at several mm to several tens of mm.

The size of the entire integrated interferometric apparatus 100 can be manufactured at a size of several cm to several tens of cm.

The interferometric apparatus 100 of the present invention integrates components of a Michelson interferometer.

Therefore, optical signals input from a first port 130 are branched, which are transmitted to a second port 140 and a third port 150. The magnitudes and phases in the optical signals transmitted from a second port 140 and a third port 150 to the outside are transformed, which are incident to the second port 140 and a third port 150. The optical signals incident to the second port 140 and the third port 150 are coupled, which are transmitted to a fourth port 160. The interference phenomenon occurs in the optical signals output from the fourth port 160 due to the difference between optical paths caused by two combined optical signals.

The optical waveguide 120 may be configured to include a first arm 121 connecting the first port to the coupler, a second arm 122 connecting a second port to the coupler, a third arm 123 connecting a third port to the coupler, and a fourth arm 124 connecting a fourth port to the coupler.

The optical waveguide 120 is formed by etching a substrate having a multi-layered structure. The optical waveguide 120 can be filled with dielectric materials serving to guide light in an etched space in order to increase the transmission efficiency of optical signals. In particular, the optical waveguide 120 may have stability against outside heat through the use of polymer materials.

Each arm 121 to 124 should change a direction of an optical path in order to transmit optical signals to the coupler. In this case, when the direction of the optical path is changed, the waveguide is designed to have a curved shape rather than being bent to be angled, in order to increase light transmission efficiency. For example, the bent portion of each arm 121 to 124 may be formed to have a curved line whose curvature is 10 mm.

In addition, the length of the first arm 121 and that of the fourth arm 124 of the waveguide 120 are necessarily not the same; however, it is preferable that the length of the second arm 122 and the third arm 123 be the same. The difference in optical paths does not occur in the integrated interferometer 100, such that the interference phenomenon occurs only by the change in refractive index generated from the bio chip.

The first port 130 may receive optical signals and transmit the received optical signals to the coupler 110 through the first arm 121. Generally, alight generating device may be connected to the first port 130.

The fourth port 160 transmits optical signals and the optical signals to be transmitted receive signals, which are synthesized in the coupler 110, through the fourth arm 124. Generally, a light detecting device may be connected to the fourth port 160.

The second port 140 may transmit and receive optical signals and transmit the transmitted optical signals and the received optical signals to the coupler 110 through the second arm 122. Generally, a reference device may be connected to the second port 140 in order to generate signals that may be interfered with the signals received in the third port 150.

The third port 150 may transmit and receive optical signals and transmit the transmitted optical signals and the received optical signals to the coupler 110 through the third arm 123. Generally, a bio chip may be connected to the third port 150.

Each port 130 to 160 may further includes a connection part to be connected with external devices. Due to the increased integration of the interferometric apparatus, the connection with the external devices becomes difficult. In order to solve the problem, the connection portion may be further provided to the interferometer to be connected with external devices. In addition, the connection part may have parts for optical connection in order to increase the input and output efficiency of the optical signals.

Since the interferometric apparatus 100 of the present invention is integrated, the distances among each of the arms 121 to 124 of the optical waveguide 120 approximate to each other. In particular, since the magnitude of the signal transmitted through the first arm is relatively large as compared to the signal transmitted through the fourth arm, it may serve as the background noise for the signal detected in the fourth arm.

Therefore, the interferometric apparatus 100 of the present invention is configured so that the direction of the first arm 121 is mutually orthogonal to the direction of the fourth arm 124 and is also orthogonal to the directions of the second arm 122 and the third arm 123, thereby solving the noise problem due to the inter-signal coupling.

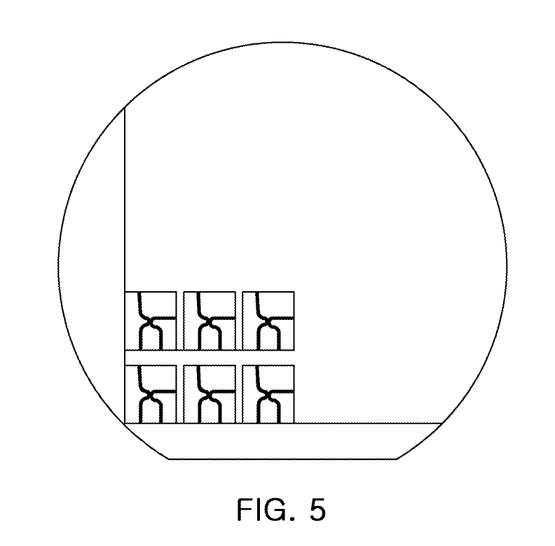

Referring to FIG. 5, the first arm 121 and the fourth arm 124 are configured as described above, such that the direction of the waveguide 120 conforms to an alignment direction of a crystal of a substrate 170. When the direction of the waveguide 120 conforms to the alignment direction of the crystal of the substrate 170, the yield of the integrated interferometric apparatus 100 is increased.

However, when the second arm 122 and the third arm 123 are formed in a parallel structure, the spaced distance between two arms may be formed to be maintained at a distance of 0.1 mm or more.

As described above, the size of the integrated interferometric apparatus 100 of the present invention is small and the components configuring the interferometric apparatus are integrated, such that the setting of the measuring device may be completed only by the connection of the optical cable, or the like. Further, since the setting of the measuring device is completed only by the connection of the optical cable, the mobility of the interferometric apparatus is provided, thereby making it possible to expand the use of the measuring system.

In addition, the size of the interferometric apparatus 100 is small, thereby making it possible to minimize the effect due to the surrounding environment. Further, there is little difference in environmental factors affecting each of the components of the interferometric apparatus 100, such that the problem of locality does not occur.

For example, when the size of the interferometric apparatus 100 is large, the environment may be different for each portion of the substrate and thus, the temperature may different for each portion of the substrate. In this case, the polarization characteristics between signals reflected from the second arm 122 and the third arm 123 are different due to different temperatures for each portion of the substrate, which serves as an error at the time of measurement. However, when the size of the interferometric apparatus 100 is small, the difference in temperature at each portion of the substrate is insignificant, thereby making it possible to reduce the error at the time of measurement.

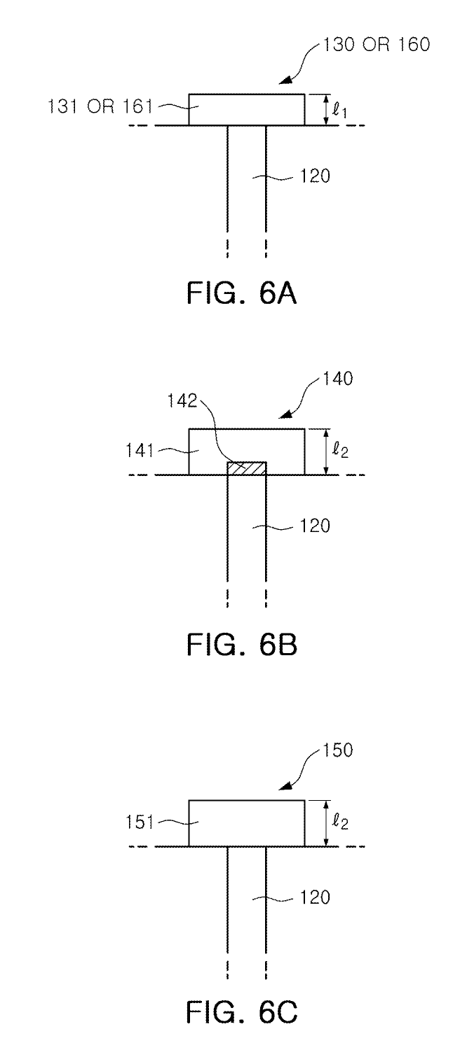

FIGS. 6A, 6B and 6C show the configurations of each port of the integrated interferometric apparatus of the present invention.

Referring to FIG. 6A, the first port and the fourth port further include connection parts 131 and 161 that facilitate the connection with external devices.

In addition, the lengths 1₁ of the connection parts 131 and 161 of the first port 130 and the fourth port 160 are not necessarily the same.

Referring to FIG. 6B, the second port 140 may further include a light absorbing unit 142 as well as the connection part 141.

The light absorbing unit 142 serves to lower the intensity of optical signals transmitted and received through the second port 130. Only when the intensity of the optical signal received through the third port 150 and the optical signal received through the second port 140 is the same, the interference phenomenon appearing by coupling two optical signals is most clearly shown. Therefore, the light absorbing unit 142 serves to meet the intensity of both signals.

Referring to FIG. 6C, the third port 150 further includes the connection part 151 that facilitates the connection with external devices.

It is preferable that the length of the connection part 141 and the light absorbing unit 142 of the second port is the same as the length l₂ of the connection part 151 of the third port. The length means a length of an optical path. In other words, the optical lengths are the same as each other so that the difference in optical paths does not occur by the connection part.

Referring to FIG. 2, the connection part may be formed in a form that guides the optical cable by etching the substrate 170 in a V-groove form.

Before the lower clad 171 is applied, the V-groove is wettably etched over the substrate. In this case, the size of the pattern to be etched is determined in consideration of the width or depth of the V-groove.

In order to perform the V-groove wet etching, the main cut-out surface ([−1,1,0]) of the silicon crystal substrate is aligned to conform to the waveguide forming direction, thereby forming a masking pattern.

Since the size of the integrated interferometric apparatus 100 is small, the alignment between apparatuses becomes an important problem when being connected with the external devices. Therefore, as described above, the connection part 140 is separately provided, such that the integrated interferometric apparatus 100 having the advantages of facilitating the alignment between the apparatuses can be manufactured.

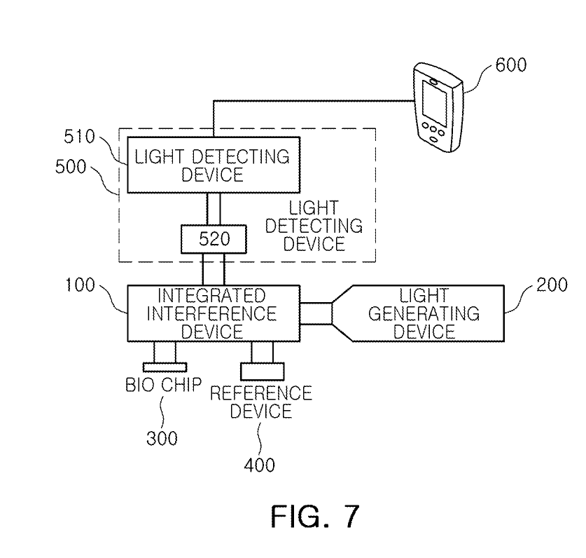

FIG. 7 is a diagram showing an overall configuration of a bio signal sensing system using the integrated interferometric apparatus of the present invention.

Referring to FIG. 7, the bio signal detection system of the present invention may be configured to include the integrated interferometric apparatus 100, a light generating device 200, a bio chip 300, a reference device 400, and a light detecting device 500. In addition, the bio signal detection system may be configured to further include a display device 600.

The integrated interferometric apparatus 100, which has a Michelson interferometer structure, has a small-sized integrated form. A description thereof is provided above and therefore, a detailed description thereof will be omitted

The light generating device 200 generates the optical signals suitable for measuring the difference in refractive index due to the antigen-antibody reaction occurring in the bio chip 300 and outputs them to the integrated interferometric apparatus 100. It is preferable that the optical signal output from the light generating device 200 is a parallel light. In addition, it is preferable that the optical signal output from the light generating device 200 is a single optical signal.

The reference device 400 is a device that reflects and outputs the received optical signals. The phase of light reflected from the reference device 400 is controlled and reflected to interfere with light reflected by the bio chip 300. Generally, the reference device 400 may be implemented as a reflector.

The light detecting device 500 measures the interference level of the optical signal output from the integrated interferometric apparatus 100 to detect the change in refractive index of the bio chip 300. The light detecting device 500 may be configured to include a probe 520 receiving the interference optical signals output from the integrated interferometric apparatus 100 and a data detector 510 extracting the data on the change in refractive index of the bio chip 300 from the received interference optical signals. In particular, the light detecting device 500 may measure the phase change to extract the data on the change in refractive index from the interference optical signals.

The display device 600 uses the optical signal detected in the light detecting device and the pre-stored parameters to calculate and display the quantitative value of a protein included in the bio chip. The display may be represented numerically or graphically.

Briefly describing the process of calculating the quantitative value of protein using the measured signals, the quantitative value of the measured signal was calculated using the reaction parameter (Turnover #, 790 sec⁻¹@ pH6.4) of the enzyme (horseradish peroxidase) used in the experiment. A method of pre-stored parameters and reading these parameters at the time of performing calculation can be used.

After the quantitative value of protein based on the parameters is calculated, the calculated values are displayed through the display device 600. As represented by Equation 1, the substrate A is subjected to the reaction such as the type in which it encounters the enzyme E to generate the intermediate materials X and obtain the color-developed products P. The products P is represented as the change in refractive index to obtain the measuring signals from the interferometric sensor system and calculate the final quantitative value through numerical calculation using steady state approximation.

A+E [symbol] X→E+P Equation 1

Although not shown, a light collection unit for performing the collection and dispersion of light while improving the transmitting and receiving efficiency may be further provided between the integrated interferometric apparatus 100 and the bio chip 300. Generally, a graded index (GRIN) lens may be used as the light collection unit.

As set forth above, according to the integrated interferometric apparatus and the bio sensor system using the same, the interferometric apparatus may be manufactured by the integrated form to minimize the effect of an environment, thereby making it possible to stably obtain signals and to minimize polarization turning characteristics occurring in the optical waveguide, thereby making it possible to improve the bio detection performance. In addition, when the light absorbing unit is provided in the third port, the present invention can obtain more clear interference signals, thereby making it possible to improve the bio detection performance.

While the present invention has been shown and described in connection with the exemplary embodiments, it will be apparent to those skilled in the art that modifications and variations can be made without departing from the spirit and scope of the invention as defined by the appended claims.

What is claimed is:

1. An integrated interferometric apparatus, comprising:
first to fourth ports through which optical signals are input and output;
a coupler branching and coupling the optical signals; and
first to fourth optical waveguides connecting the first to fourth ports to the coupler and transmitting optical signals,
wherein the coupler branches the optical signals input from the first port and transmits them to the second port and the third port and couples the optical signals transmitted from the second port and the third port and transmits them to the fourth port, and
the first port and the fourth port are disposed so that the first optical waveguide connected to the first port is orthogonal to the fourth optical waveguide connected to the fourth port.

2. The integrated interferometric apparatus of claim 1, wherein the coupler and the optical waveguide are formed by sequentially stacking a lower clad, a core, and an upper clad on an upper portion of a substrate of silicon oxide and silicon nitride.

3. The integrated interferometric apparatus of claim 1, wherein the length of the second optical waveguide connected to the second port is the same as that of the third optical waveguide connected to the third port.

4. The integrated interferometric apparatus of claim 1, wherein when the second optical waveguide connected to the second port is parallel with the third optical waveguide connected to the third port, the interval between the optical waveguides is 0.1 mm or more.

5. The integrated interferometric apparatus of claim 1, wherein the third port further includes a light absorbing unit that makes the intensity of the optical signals received in the second port and the intensity of the optical signals received in the third port the same.

6. The integrated interferometric apparatus of claim 1, wherein each of the first to fourth ports further includes a connection part for connecting with the optical device.

7. The integrated interferometric apparatus of claim 6, wherein the connection part is formed by etching the substrate in a V-groove form.

8. The integrated interferometric apparatus of claim 6, wherein each connection part includes parts for optically connecting the optical devices connected to each port.

9. A bio detection sensor system, comprising:
a light generating device generating optical signals required for measurement;
a reference device reflecting input optical signals;
a bio chip device;
a light detecting device detecting received optical signals; and
an integrated interferometer apparatus that includes a first port into which optical signals of the light generating device are input, a second port receiving the optical signals from the bio chip or outputting optical signals to the bio chip, a third port inputting the optical signals from the reference device or outputting the optical signals to the reference device, a fourth port outputting the optical signals to the light detecting device, a coupler branching the optical signals input from the first port and transmitting them to the second port and the third port and coupling the optical signals transmitted from the second port and the third port and transmitting them to the fourth port, and first to fourth optical waveguides connecting the first to fourth ports to the coupler and transmitting the optical signals, wherein the first port and the fourth port are disposed so that the direction of the first optical waveguide connected to the first port is orthogonal to the direction of the fourth optical waveguide connected to the fourth port.

10. The bio detection sensor system of claim 9, wherein the coupler and the optical waveguide are formed by sequentially stacking a clad and a core on a substrate of silicon oxide and silicon nitride after etching.

11. The bio detection sensor system of claim 9, wherein in the integrated interferometric apparatus, the length of the second optical waveguide connected to the second port is the same as that of the third optical waveguide connected to the third port.

12. The bio detection sensor system of claim 9, wherein the integrated interferometric apparatus further includes a light absorbing unit that makes the intensity of the optical signals received in the second port and the intensity of the optical signals received in the third port the same.

13. The bio detection sensor system of claim 9, wherein each of the first port, the second port, the third port, and the fourth port further includes connection parts for connecting with the light generating device, the light detecting device, the reference device, and the bio chip.

14. The bio detection sensor system of claim 13, wherein the connection part is formed by etching the substrate in a V-groove form.

15. The bio detection sensor system of claim 13, wherein each connection part includes parts for optically connecting the light generating device, the light detecting device, the reference device, and the bio chip to each port.

16. The bio detection sensor system of claim 9, wherein the light detecting device measures the change in phase.

17. The bio detection sensor system of claim 9, further comprising a display device calculating and displaying a quantitative value of protein included in the bio chip by using the optical signals detected in the light detecting device and pre-stored parameters.

18. The bio detection sensor system of claim 9, further comprising a terminal between the second port and the bio chip.

19. The bio detection sensor system of claim 9, wherein the bio chip is disposable.

20. The bio detection sensor system of claim 9, wherein the light absorbing unit that makes the intensity of the optical signals received in the second port and the intensity of the optical signals received in the third port the same is further disposed between the third port and the reference device.
